(19) United States
(12) Patent Application Publication
(10) Pub. No.: US 2007/0032259 A1
(43) Pub. Date: Feb. 8, 2007

(54) Method and apparatus for voice amplitude feedback in a communications device

(76) Inventor: George Gounaris, West Palm Beach, FL (US)

Correspondence Address: SACCO & ASSOCIATES, PA, P.O. BOX 30999, PALM BEACH GARDENS, FL, 33420-0999, US

(21) Appl. No.: 11/198,742

(22) Filed: Aug. 5, 2005

(51) Int. Cl. H04M 1/00

(52) U.S. Cl. 455/550.1

(57) ABSTRACT

A mobile telecommunication device can include voice signal monitoring. A characteristic of a signal produced in the telecommunication device can be monitored that is directly or indirectly indicative of a volume of a user's voice spoken into the device. A comparator can be provided for comparing the characteristic or characteristics to one or more threshold values. The comparator can be comprised of electronic circuitry, software or a combination of the two. In any case, an alerting system is provided that is responsive to the output of the comparator, for automatically alerting the user of the device when the characteristic is outside a desired range.

### BACKGROUND OF THE INVENTION

1. Statement of the Technical Field

The inventive arrangements relate to mobile communications devices, and more particularly to wireless mobile cellular telephones.

2. Description of the Related Art

Wireless mobile telephones are well known in the field of communications. However, persons speaking on wireless phones often have a tendency to speak in an excessively loud tone of voice. It has been suggested that one reason users often revert to an excessively loud voice when speaking on cellular mobile phones is attributable to the user's awareness that the party on the other end of the line is some distance away, and naturally is not visible to the speaker. Under these circumstances, there is a natural tendency for people to speak loudly.

Still, the tendency of people to speak in an excessively loud tone of voice is generally not present with conventional wired phones. This is due to the fact that a user's voice volume is determined to a substantial degree by auditory feedback. Auditory feedback is the relative loudness level at which telephone users are able to hear their voice. With conventional wired telephones, an audio signal is fed back to the user's own earpiece so they can hear their voice at a predetermined loudness level. This audio signal is sometimes called sidetone. Persons speaking on the phone naturally will tend to adjust the loudness level of their voice to produce a comfortable level of audio in the earpiece. In contrast, wireless mobile cellular telephones do not generally provide feedback of a user's own voice in the receiver. Consequently, they tend to speak at relatively loud levels that are sometimes annoying to those around them.

### SUMMARY OF THE INVENTION

The invention generally concerns a method for guiding a user of a mobile telecommunication device to a desired voice volume. The method includes monitoring at least one characteristic of a signal produced in a telecommunication device that is directly or indirectly indicative of a volume of a user's voice spoken into the device. The method can further include automatically alerting the user of the device when such monitoring indicates that the characteristic is outside a desired range. When the characteristic is out of the desired range, it indicates that the user is speaking in an unnecessarily loud or soft tone of voice.

The method can further include the step of automatically comparing the chosen characteristic to one or more threshold values to determine if the characteristic is within the desired range. For example, threshold value can correspond to a minimum or maximum volume level of the user's voice which is preferably not to be exceeded. The maximum volume level can be selected so as to correspond to a minimum required volume necessary for obtaining a predetermined quality of communication performance from the telecommunications device. Alternatively, or in addition to this condition, the maximum volume level can be selected to minimize the extent to which the user's voice will be heard by persons who are physically located in the user's vicinity. The minimum level can be selected to ensure adequate audio quality. The threshold level in either case can be preset by the manufacturer, by the user, or may be set automatically using a dynamic process.

Various different techniques can be used for alerting the user when he or she is speaking in an unnecessarily loud or soft tone of voice. For example, the alert signal can be visual, audible and/or tactile in nature. According to one aspect of the invention, an audible tone can be produced in an earpiece of the mobile telecommunications device to alert the user regarding their loud tone of voice. Alternatively, this step can include vibrating a headphone or handset comprising the mobile telecommunication device.

According to another aspect, the invention can include a mobile telecommunication device. The device can include suitable circuitry, software or a combination of these for voice signal monitoring. More particularly, at least one characteristic of a signal produced in the telecommunication device can be monitored that is directly or indirectly indicative of a volume of a user's voice spoken into the device. A comparator can be provided for comparing the characteristic or characteristics to one or more threshold values.

The comparator can be comprised of electronic circuitry, software or a combination of the two. In any case, an alerting system is provided that is responsive to the output of the comparator, for automatically alerting the user of the device when the characteristic is outside a desired range. The alerting system can be chosen to produce any suitable alert signal. For example the alerting system can include a device capable of producing a visible, audible or tactile alert. According to one aspect of the invention, the alerting system audible tone can be produced in an earpiece of the mobile telecommunications device to alert the user regarding their loud tone of voice. Alternatively, the alerting system can include a device capable of vibrating a handset comprising the mobile telecommunication device.

Within the mobile telecommunication device, the one or more threshold values can be selected to correspond to a preferred maximum volume level of the user's voice. According to one aspect of the invention, the maximum volume level can be set so that it is approximately the least volume necessary for obtaining a predetermined quality of communication performance from the telecommunications device. Alternatively, the maximum volume level can be subjectively selected to minimize the extent to which the user's voice will be heard by persons who are physically located in the user's vicinity. The threshold level can be preset by the manufacturer, by the user, or can be set automatically using a dynamic process.

### BRIEF DESCRIPTION OF THE DRAWINGS

FIG. 1 is block diagram of a wireless telecommunication device.

FIG. 2 is a block diagram of the analog base band processor in FIG. 1.

FIG. 3 is a block diagram of the digital base band processor in FIG. 1.

FIG. 4 is a flow chart that is useful for understanding the process of the present invention.

### DETAILED DESCRIPTION OF THE PREFERRED EMBODIMENTS

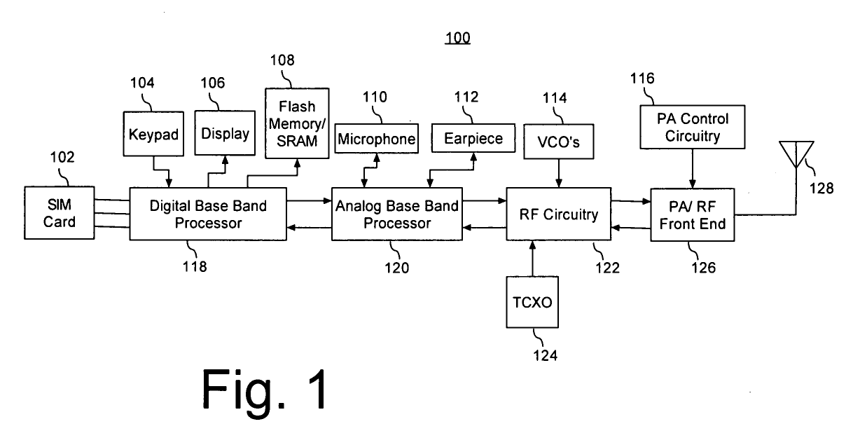

A block diagram of a wireless cellular telephone is shown in FIG. 1. The state of the art in wireless cellular telecommunications includes a number of communications protocols that are well known. For example, wireless cellular communications can be designed around various standards including TDMA, GSM and CDMA based systems. For convenience, the basic block diagram in FIG. 1 that will be used to describe the invention is that of a typical GSM handset. However, it will be readily appreciated that the invention is not limited to any particular communication protocol or system architecture. Instead, the invention can be applied in practically any type of mobile wireless phone.

Referring to FIG. 1, a typical GSM telephone handset 100 can include an antenna 128 connected to a power amplifier (PA)/RF front end 126. The PA/RF front end can typically include transmitter power amplifier circuits, RF matching circuitry and/or filtering circuits. Power amplifier control circuitry 116 can be provided for controlling the output power of the handset 100 in response to instructions received from a base station. The handset also includes RF circuitry 122 for processing RF signals. The RF circuitry block can include additional filtering and circuitry for converting the RF signal received at the antenna to one or more intermediate frequencies, and ultimately a base band signal. Conversely, base band signals received by the RF circuitry 122 can be converted to RF before being passed to the RF front end. For the purposes of the frequency conversion process, one or more voltage controlled oscillators 114 and a temperature compensated crystal oscillator TCXO 124 can be provided.

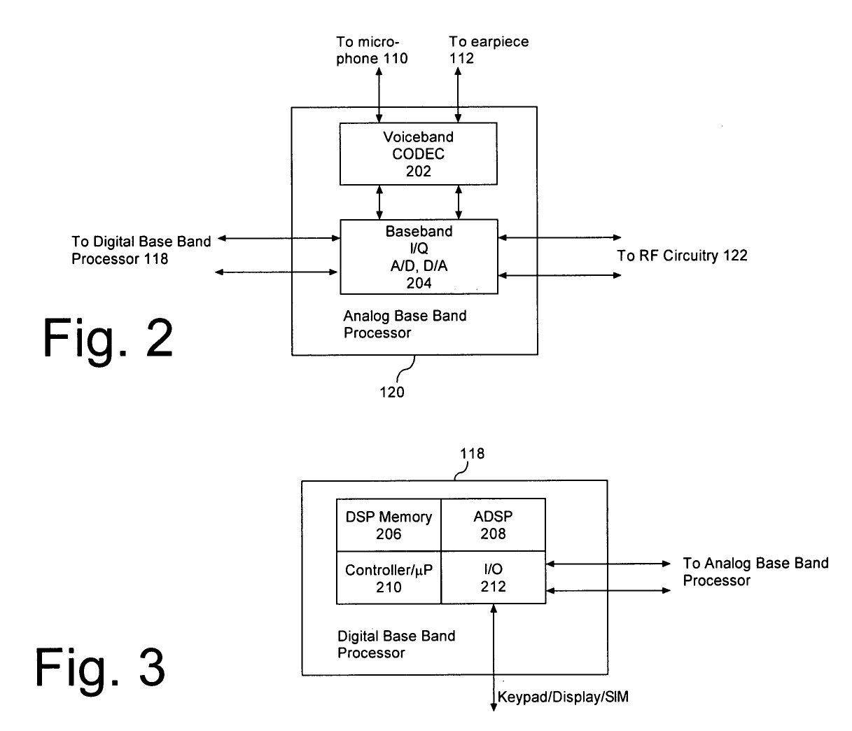

The telephone handset 100 can also include analog base band processor 120. The analog base band processor 120 can receive input audio signals from microphone 110 and provide output audio to an earpiece 112. The analog base band processor is shown in more detail in FIG. 2. Audio signals received by the analog base band processor can be modified by digital base band processor 118 to conform to the particular communication protocols implemented within a cellular system architecture. For example, in the case of a GSM type system as here described, the digital base band processor can provide digital signal processing resources as necessary to implement the GSM system protocol and manage system communications with a base station.

FIG. 2 shows a more detailed block diagram of analog base band processor 120. The analog base band processor 120 can include a voiceband CODEC 202 for receiving audio input signal from microphone 110 and generating audio output to earpiece 112. Any suitable voiceband CODEC can be used for this purpose. However, in a GSM handset, the CODEC will typically operate at 13 kbits/s and will commonly make use of a Regular Pulse Excited (RPE) type coding system. Still, the invention is not limited in this regards and any other suitable vocoder arrangement can be used. The analog base band processor 120 can generally include a base band In-phase and Quadrature (I/Q) modulator/demodulator, analog to digital conversion (A/D) circuitry, and digital to analog conversion (A/D) circuitry 204.

Those skilled in the art will appreciate that the analog baseband processor 120 shown in FIG. 2 is merely one example of an analog base band processor as may be used in a GSM cellular telephone handset. The invention is not intended to be limited to this particular processor architecture or even to the GSM communication protocol.

As shown in FIG. 3, the digital base band processor 118 can include several components including an adaptive signal processor (ADSP) 208, DSP memory 206, a microprocessor or suitable controller 210 for coordinating and controlling the various functions of the wireless handset, and suitable I/O circuitry 210 for communicating data and/or control signals to the analog base band processor 120. The microprocessor or controller can be provided with a flash memory/SRAM 108 to support DSP processing and store other user data. The digital base band processor 118 can also receive user inputs by way of a keypad 104, and communicate with a data display 106 for interacting with a user. Finally, the telephone handset will also generally include a digital base band processor 118 for implementing network protocols and a SIM card 102. The SIM card contains the personal identification number of the subscriber and identifies the network to which the subscriber belongs.

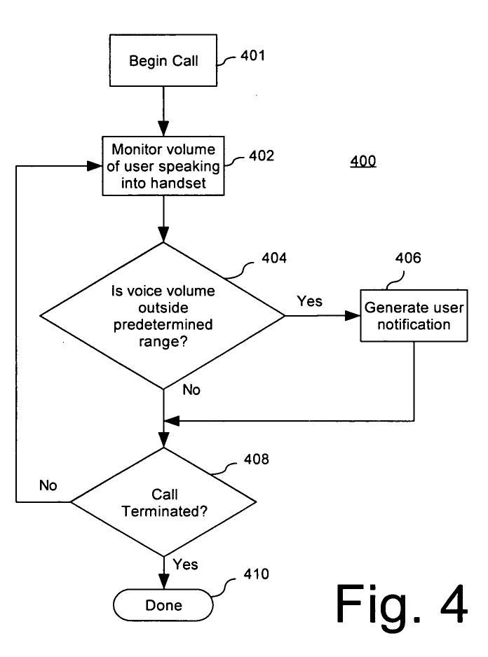

FIG. 4 shows a flowchart 400 that is useful for understanding the inventive arrangements that can be implemented in a telephone handset, such as the one which is shown in FIGS. 1-3. The process can be implemented in the controller/microprocessor 210 which forms a part of the digital base band processor, which monitors the audio data via I/O interface 212 with the analog base band processor 118. The process can begin in step 401 when a call is initiated by the user of the telephone handset or a third party who is calling the handset. In step 402 the system begins monitoring the voice volume of the user as words are spoken into a microphone of a handset or headset.

Various factors may affect the relative volume at which a user needs to speak in order to achieve proper modulation characteristics, overcome background noise, and generally achieve good quality communications. In many cases, the user will speak louder or softer than is technically necessary for achieving quality voice communications. Accordingly, in step 404, a comparison is made to determine if the user's voice volume exceeds a predetermined level. The comparison can be performed by controller/microprocessor 210. The controller will compare the measured characteristic value to a threshold value corresponding to the predetermined level. If the user's voice is determined to be outside the range defined by the predetermined value, then a user notification can be generated in step 406 to alert the user that he is speaking in a tone of voice that is louder or softer than desired. In step 408, a determination can be made as to whether the call has terminated. If so, the process will terminate in step 410. However, if the call is still in progress, the process can return to step 402 and the process will continue.

The predetermined level in step 404 to which the volume of a speaker's voice is compared can be set in any one of several ways. For example, the level could be preset at the time of manufacture based on the technical requirements of the telephone handset. Testing can be performed to determine the minimum user voice volume necessary for achieving quality voice communications using the particular handset. Once the value has been determined, it can be stored in a memory. For example the data can be stored in a memory associated the digital base band processor.

As an alternative to a fixed value set at the time of manufacture, the predetermined value can be at least partially determined by a user. For example, a user could be permitted to set the predetermined level to a somewhat higher or lower threshold level. Changing the predetermined level in this way could allow the user some flexibility within an acceptable range to adjust the level at which the handset will generate notifications in step 406.

According to another aspect of the invention, the predetermined level can be set dynamically by the device. In that case, the controller/microprocessor 210 can monitor one or more characteristics of the audio signals generated by a user's voice when speaking into the handset. The controller/microprocessor can be programmed to automatically select the predetermined level based on these measured results. For example, the predetermined level can be adjusted to correspond to a higher volume if it is determined that there is substantial background noise that the speaker's voice needs to overcome. Alternatively, the predetermined level could be modified based on the frequency characteristics of the user's voice, if those characteristics are known to negatively or positively affect the clarity of the audio reproduced. Those skilled in the art will appreciate that the invention is not intended to be limited to the foregoing examples. Instead, any other appropriate criteria can be used to dynamically set the predetermined level in step 404.

Those skilled in the art will appreciate that the volume of a user's voice can be measured in step 404 at a variety of different signal processing points in the handset. For the purposes of the present invention, the volume measurement can occur before processing the audio signal in the voiceband CODEC, after processing the signal in the voice band CODEC, or at some later processing stage. The precise point at which voice volume is sampled is not critical. However, those skilled in the art will recognize that the presence of any automatic gain control (AGC), equalization, or other processing can distort the apparent volume of the user's speaking voice and should be properly accounted for. In this regard, it can be advantageous to perform any such sampling before AGC, equalization or other processing in some instances.

In step 406, a variety of methods can be used to generate a user notification that their voice volume exceeds the predetermined level in step 404. For example, the handset can be made to vibrate. Alternatively, a visual stimulus can be provided by the handset in the form of a flashing lamp or LED. However, the flashing lamp may be difficult to observe by a user and should be placed at a location where it is highly visible so as to attract the user's attention when speaking. Yet another embodiment of the invention can include an audible alert that is communicated to the handset user. The audible alert could be added to the audio signal communicated to the user's ear when a call is in progress. Alternatively, a separate audio transducer mechanism could be used. In any case, if an audio tone or signal is used, it is preferred that the signal be selected to have an amplitude, duration, and period so as not to unduly interfere with the user's ongoing conversation.

Of course the user notification is not limited to the method described above. Other notifications are also possible. For example, a sidetone signal could be generated in the handset and communicated to the earpiece. In that case, the volume of the user's voice generated by the earpiece could be dynamically controlled. Where a user was speaking in an excessively loud tone of voice, the sidetone signal could be increased in amplitude so that the user would hear his in his earpiece at a sufficiently loud volume to cause the user to recognize that he was speaking too loudly. The precise amplitude of the sidetone signal and communicated to the user's ear could be determined experimentally.

Similarly, while the invention has been described herein as being implemented primarily in software, using existing on-board processing facilities provided by handset, the invention is not limited in this regard. For example, dedicated analog circuitry can perform some or all of the functions associated with the process described in relation to FIG. 4. The monitoring circuitry can be integrated directly into the microphone or into the voiceband CODEC. Alternatively, one or more of the processing steps can be performed by other digital or analog processing resources that can be provided.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as described in the claims.

We claim:

1. A method for guiding a user of a mobile telecommunication device to a desired voice volume, comprising:
monitoring at least one characteristic of a signal produced in a telecommunication device that is directly or indirectly indicative of a volume of a user's voice spoken into the device;
responsive to said monitoring step, automatically alerting said user of said device when said characteristic is outside a desired range.

2. The method according to claim 1, further comprising automatically comparing said characteristic to at least one threshold to determine if said characteristic is within said desired range.

3. The method according to claim 2, further comprising selecting said at least one threshold value to correspond to a maximum or minimum volume level of said user's voice.

4. The method according to claim 3, further comprising selecting said maximum volume level to correspond to a minimum required volume necessary for obtaining a predetermined quality of communication performance from said telecommunications device.

5. The method according to claim 3, further comprising selecting said maximum volume level to a predetermined value selected to minimize the extent to which the user's voice will be heard by persons who are physically located in the user's vicinity.

6. The method according to claim 1, wherein said alerting step comprises generating at least one signal detectable by said user and selected from the group consisting of a visual, audible and tactile signal.

7. The method according to claim 1 further comprising selecting said alerting step to include producing an audible tone in an earpiece of said mobile telecommunications device.

8. The method according to claim 1, further comprising selecting said alerting step to include vibrating a handset comprising said mobile telecommunication device.

9. The method according to claim 2, further comprising automatically selectively determining said at least one threshold.

10. A mobile telecommunication device, comprising:
voice signal monitoring means for monitoring at least one characteristic of a signal produced in said telecommunication device that is directly or indirectly indicative of a volume of a user's voice spoken into the device;
comparator means for comparing said at least one characteristic to at least one threshold value; and
alerting means responsive to said comparator means, for automatically alerting the user of said device when said characteristic is outside a desired range.

11. The mobile telecommunications device according to claim 10, wherein said at least one threshold value corresponds to a preferred maximum volume level of said user's voice.

12. The mobile telecommunications device according to claim 11, wherein said maximum volume level is approximately the least volume necessary for obtaining a predetermined quality of communication performance from said telecommunications device.

13. The mobile telecommunications device according to claim 10, wherein said alerting means produces an alert signal that is selected from the group consisting of visual, audible and tactile.

14. The telecommunication device according to claim 10, further comprising means for automatically selectively determining said at least one threshold.

15. A method for guiding a user of a mobile telecommunication device to a desired voice volume, comprising:
monitoring at least one characteristic of a signal produced in a telecommunication device that is directly or indirectly indicative of a volume of a user's voice spoken into the device;
selecting at least one threshold value for said characteristic that corresponds with a desired maximum or minimum volume level of said user's voice;
automatically comparing said characteristic to said at least one threshold to determine if said characteristic is within a desired range defined by said at least one threshold;
responsive to said monitoring step, automatically alerting said user of said device when said characteristic is outside said desired range by generating at least one of an audible tone, a tactile sensation and a visual indication.

16. The method according to claim 15, further comprising repeating said alerting step on a periodic basis until said characteristic is within said desired range.

17. The method according to claim 15, wherein said audible tone is communicated to said user through an ear piece of said mobile telecommunications device.

18. The method according to claim 15, wherein said tactile sensation is produced by vibrating said mobile telecommunication device.
